(19) United States
(12) Patent Application Publication
(10) Pub. No.: US 2022/0203351 A1
(43) Pub. Date: Jun. 30, 2022

(54) MODULAR REACTION VESSEL CARTRIDGE FOR PHOTOMETRIC ANALYZERS AND METHODS FOR MAKING SAME

(71) Applicant: AWARENESS TECHNOLOGY, INC., Palm City, FL (US)

(72) Inventors: Joshua E. Orlandi, Port St. Lucie, FL (US); Daniel P. Mammolito, Jupiter, FL (US); Mary Freeman, Palm City, FL (US)

(73) Assignee: AWARENESS TECHNOLOGY, INC., Palm City, FL (US)

(21) Appl. No.: 17/139,727

(22) Filed: Dec. 31, 2020

(51) Int. Cl. B01L 3/00; G01N 21/03

(52) U.S. Cl. CPC B01L 3/502; B01L 2200/16; G01N 21/0303; B01L 3/523

(57) ABSTRACT

A modular reaction vessel cartridge for a photometric reagent analyzer includes a hollow cuvette defining a filling chamber defining an upper orifice through which a first reagent is communicated, a dispensing opening below the upper orifice and through which a second reagent is communicated into the filling chamber, a read chamber below the dispensing opening and fluidically communicating with the filling chamber, and a dispensing control chamber above the read chamber having an exit fluidically communicating with the dispensing opening, defining a receiving opening through which the second reagent is communicated into the control chamber, and a plunger slidably and fluid-tightly disposed in the control chamber and defining therebetween a volume shaped to hold the second reagent such that, responsive to the plunger being moved into the filling chamber, fluid in the control chamber is dispensed into at least the filling chamber without fluid in the cuvette being transferred out from the cuvette.

### STATEMENT REGARDING FEDERALLY SPONSORED RESEARCH OR DEVELOPMENT

Not Applicable

### FIELD OF THE INVENTION

The present systems, apparatuses, and methods lie in the field of liquid test equipment and testing processes. The present disclosure relates to a modular cartridge as a liquid test reaction vessel used in photometric analyzers.

### BACKGROUND OF THE INVENTION

Photometric analysis includes measurements in the visible, ultraviolet, and infrared regions of the spectrum. It generally involves comparison of the intensity of radiation passing through a sample of the material being analyzed with the initial intensity or the intensity of a reference sample. The method of photometric analysis that uses visible light is called colorimetry. Photometric analysis in which the intensities of the monochromatic components of transmitted radiation are scanned is called spectrophotometry. Methods similar to photometric analysis include atomic absorption analysis, turbidimetric analysis, and nephelometric analysis.

Reaction vessels for photometric analysis are typically square or cylindrical. They arrive at the photometric analyzer with a reagent therein and a sample is added to the reagent. Alternatively, the reaction vessels arrive with a sample and the reagent is added to the sample. These cylindrical or square vessels typically have an internal reaction volume of approximately 350 microliters or more.

The prior methods require the purchase of a large amount of reagent, once opened those reagents have a limited useable shelf life. In many cases the entire reagent many not be used creating waste of expensive resources. Previous vessels would require the reagents to be hand pipetted increasing laboratory labor. Manual reagent additions are also subject to human error in both volume and timing as well as imprecision if the vessel must be removed from temperature control and mixing while the addition occurs. Other options include a fully automated pipettor which adds significantly to instrument cost and also requires maintenance and calibration.

Thus, a need exists to overcome the problems with the prior art systems, designs, and processes as discussed above.

### SUMMARY OF THE INVENTION

The systems, apparatuses, and methods described provide a modular reaction vessel cartridge for photometric analyzers and methods for making same that overcome the hereinafore-mentioned disadvantages of the heretofore-known devices and methods of this general type and that provide such features in a single-use configuration.

There are many advantages of this cuvette or reading vessel over the prior art. The design of the vessel with a built-in dispensing system allows for an accurate low pressure dispense of the reagent at the exact specified time in the testing procedure. The design ensures an even dispense of the reagent with little to no splattering or spraying of fluid. The built-in dispense system does not permit any contamination interaction with the analyzer conducting the test procedure. Also, only one pipette of the sample is needed at the beginning of the test procedure, thereby eliminating the manual step of adding the second reagent to the mixture of the first reagent and the pipetting of the sample. The vessel design allows for all other test steps to be automated without the need for an expensive automated pipetting machine. The vessel is easy to manufacture and has a low cost, as well as being simple to fill and seal. At the manufacturer, the first reagent is placed in the mixing or reaction chamber or cuvette. The second reagent is also loaded by the manufacturer in the dispensing control chamber surrounding the pipetting device, also referred to as the reagent-dispensing plunger. The first reagent is sealed by a foil and the second reagent is sealed by the plunger itself. The design of the plunger allows for easy adjustment of fluid volumes by adjustment of the plunger dimensions in, for example, length, width, and height. This feature allows a multitude of different tests to be performed using the same design of the reaction vessel. The individually packaged and sealed vessels allow for the user to only use the needed reagent at the time, eliminating expensive waste. In the prior art, to pipette the sample or second reagent in the cuvette, the mixing process in the cuvette needed to be stopped. In the instant invention, the mixing (e.g., by a stir bar) can be conducted throughout the process and stopped only when desired. Use of only a designated amount of the reagents within the cuvette and pipetting device of the instant invention and sealing them independently until use efficiently utilizes these supplies with little waste and contamination and virtually eliminating human error in volume, timing, temperature control, and/or mixing. Unlike reagent pipetting, using the devices, systems, and methods described herein, no pipet tip or any other component of the instrument comes in contact with the reaction, thus avoiding any possibility of contamination from test-to-test carryover

Another disadvantage in the prior art is that photometric analyzers perform photometric analyses and turbidimetric analyzers perform turbidimetric analyses. These require separate machines. The systems and methods described are capable of performing both analyses. These systems take photometric readings to determine turbidimetric results. In other words, the systems and methods look for light scattered by turbidity at a certain wavelength photometrically.

With the foregoing and other objects in view, there is provided, a modular reaction vessel cartridge for a photometric analyzer comprising a cartridge body comprising an integral cuvette comprising a filling chamber defining an upper orifice through which a first fluid is to be communicated, and a dispensing opening through which a fluid is to be communicated, and a read chamber below the filling chamber and fluidically connected to the filling chamber, and an integral pipetting portion comprising a dispensing control chamber having an exit fluidically communicating with the dispensing opening, having an interior surface, and defining a receiving opening through which a second fluid is to be communicated, and a dispensing plunger comprising a loading end fluid tightly sealed to the interior surface of the dispensing control chamber, and a dispensing end fluid tightly sealed to the interior surface of the dispensing control chamber, wherein the dispensing plunger is movably disposed within the dispensing control chamber such that, responsive to the dispensing end being moved from the dispensing control chamber into the filling chamber, fluid in the dispensing control chamber is dispensed into at least the filling chamber without fluid in the cartridge body being transferred out from the cartridge body.

With the objects in view, there is also provided a modular reaction vessel cartridge for a photometric reagent analyzer comprising a hollow cuvette defining a filling chamber defining an upper orifice through which a first reagent is to be communicated, a dispensing opening below the upper orifice and through which a second reagent is to be communicated into the filling chamber, a read chamber below the dispensing opening and fluidically communicating with the filling chamber, and a dispensing control chamber above the read chamber, having an exit fluidically communicating with the dispensing opening, and defining a receiving opening through which the second reagent is to be communicated into the dispensing control chamber, and a dispensing plunger slidably and fluid-tightly disposed in the dispensing control chamber and defining therebetween a volume shaped to hold the second reagent such that, responsive to the dispensing plunger being moved into the filling chamber, fluid in the dispensing control chamber is dispensed into at least the filling chamber without fluid in the cuvette being transferred out from the cuvette.

With the objects in view, there is also provided a photometric analyzer comprising a modular reaction vessel cartridge and a frame comprising a cartridge drawer movably connected to the frame, the cartridge drawer comprising a cartridge receiver shaped to removably contain the reaction vessel cartridge, and a dispensing system having a dispensing actuator operatively connected to the dispensing plunger when the reaction vessel cartridge is disposed in the cartridge receiver to move the dispensing plunger, and a body connected to the frame and comprising a display configured to provide information to a user.

In accordance with another feature, the cuvette comprises a first reagent in the read chamber selected from at least one of a solution, a blend, a compound, a suspension, a tincture, an infusion, an emulsion, a colloid, a gel, a dissolvent, an elixir, an extract, a fluid, a liquid, an aerosol of one of a single substance or a mixture of substances.

In accordance with a further feature, there is provided the first fluid as a first reagent in the read chamber and the second fluid as a second reagent in the dispensing control chamber.

In accordance with an added feature, the cartridge body further comprises an identifier indicating a set of test data associated with the first and second reagents.

In accordance with an additional feature, there is provided a mixer within the read chamber and configured to mix fluids within the read chamber.

In accordance with yet another feature, the mixer is at least one of a magnetic mixer, a sonic mixer, and a vibration mixer.

In accordance with yet a further feature, there is provided a cover fluid-tightly sealing the upper orifice.

In accordance with yet an added feature, the cover is a sealing foil.

In accordance with yet an additional feature, the cuvette has a maximum volume of approximately 4000 μl.

In accordance with again another feature, at least a portion of the read chamber is optically clear.

In accordance with again a further feature, the dispensing plunger is a single-stop having a barbell shape and forms peripheral liquid-tight seals between the dispensing plunger and the dispensing control chamber.

In accordance with again an added feature, the dispensing plunger is a multi-stop shape to define peripheral liquid-tight seals between wider portions of the dispensing plunger and the dispensing control chamber.

In accordance with again an additional feature, the dispensing plunger is a modular set of a plurality of dispensing plungers each having a different shape from one another to define different second fluid volumes between each of the plurality of dispensing plungers and the dispensing control chamber.

In accordance with still another feature, the shape differs by at least one of an intermediate diameter, a proximal end thickness, a distal end thickness, and length.

In accordance with still a further feature, a material of the dispensing plunger is at least one of PTFE, PVDF, PFA, PEEK, and CPVC.

In accordance with still an added feature, the filling chamber has an interior surface portion opposite the dispensing opening at a given distance and the dispensing plunger has a distal surface and a longitudinal length at least as long as the given distance such that, in a full dispensing position, the distal surface touches the interior surface portion.

In accordance with still an additional feature, the read chamber and the filling chamber define a transition therebetween having a cross-section that expands laterally from the read chamber toward the filling chamber.

In accordance with another feature, the dispensing control chamber has a maximum volume of approximately 280 μL.

In accordance with a further feature, the cuvette has a minimum volume of approximately 580 μL.

In accordance with an added feature, the cuvette has a maximum volume of approximately 4000 μL.

In accordance with an additional feature, the read chamber has a minimum volume of approximately 500 μL.

In accordance with yet another feature, the cartridge body has a front-to-back depth of approximately 1.5 inches and a height of approximately 1.33 inches.

In accordance with yet a further feature, the dispensing actuator is configured to movably dispose the dispensing plunger within the dispensing control chamber such that, fluid in the dispensing control chamber is dispensed into at least the filling chamber without fluid in the cartridge body being transferred out from the cartridge body.

In accordance with yet an added feature, at least one of the dispensing actuator and the dispensing plunger is configured to removably lock the cartridge body in the cartridge drawer and prevent removal of the cartridge body until unlocking occurs.

In accordance with yet an additional feature, at least one of the dispensing actuator and the dispensing plunger is configured to removably lock the cartridge drawer in a closed position with respect to the frame and prevent movement of the cartridge drawer until unlocking occurs.

In accordance with again another feature, at least one of the frame and the cartridge drawer comprises a photometric reader disposed with respect to the reaction vessel cartridge to photometrically read a substance within at least the read chamber of the reaction vessel cartridge.

In accordance with again a further feature, at least one of the frame and the cartridge drawer comprises a heater configured to control temperature within and at least the read chamber of the reaction vessel cartridge.

In accordance with again an added feature, the heater keeps the read chamber at a controlled temperature of between approximately 25° C. and approximately 37±0.5° C.

In accordance with again an additional feature, at least one of the frame and the cartridge drawer comprises a reader configured to read an identification indicator on the reaction vessel cartridge.

In accordance with a concomitant feature, the identification indicator is one of an RFID tag and a barcode.

Although the systems, apparatuses, and methods are illustrated and described herein as embodied in a modular reaction vessel cartridge for photometric analyzers and methods for making same, it is, nevertheless, not intended to be limited to the details shown because various modifications and structural changes may be made therein without departing from the spirit of the invention and within the scope and range of equivalents of the claims. Additionally, well-known elements of exemplary embodiments will not be described in detail or will be omitted so as not to obscure the relevant details of the systems, apparatuses, and methods.

Additional advantages and other features characteristic of the systems, apparatuses, and methods will be set forth in the detailed description that follows and may be apparent from the detailed description or may be learned by practice of exemplary embodiments. Still other advantages of the systems, apparatuses, and methods may be realized by any of the instrumentalities, methods, or combinations particularly pointed out in the claims.

Other features that are considered as characteristic for the systems, apparatuses, and methods are set forth in the appended claims. As required, detailed embodiments of the systems, apparatuses, and methods are disclosed herein; however, it is to be understood that the disclosed embodiments are merely exemplary of the systems, apparatuses, and methods, which can be embodied in various forms. Therefore, specific structural and functional details disclosed herein are not to be interpreted as limiting, but merely as a basis for the claims and as a representative basis for teaching one of ordinary skill in the art to variously employ the systems, apparatuses, and methods in virtually any appropriately detailed structure. Further, the terms and phrases used herein are not intended to be limiting; but rather, to provide an understandable description of the systems, apparatuses, and methods. While the specification concludes with claims defining the systems, apparatuses, and methods of the invention that are regarded as novel, it is believed that the systems, apparatuses, and methods will be better understood from a consideration of the following description in conjunction with the drawing figures, in which like reference numerals are carried forward.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the systems, apparatuses, and methods. Advantages of embodiments of the systems, apparatuses, and methods will be apparent from the following detailed description of the exemplary embodiments thereof, which description should be considered in conjunction with the accompanying drawings in which:

FIG. 1 is a fragmentary, exploded, perspective view from above a photometric analyzer with a modular reaction vessel cartridge above a cartridge drawer in a loading position;

FIG. 2 is a fragmentary, partially transparent, right side elevational view of the analyzer with the drawer in an analyzing position and containing therein the cartridge;

FIG. 3 is a fragmentary, enlarged portion of the cartridge body of FIG. 2 along section line III-III;

FIG. 4 is a fragmentary, partially cross-sectional, partially transparent, front elevational view of the analyzer and cartridge of FIG. 2 showing a read path of the analyzer;

FIG. 5 is a perspective, transparent, and vertically cross-sectional view of the cartridge of FIG. 1 with reagent in a read chamber and with a reagent dispensing plunger in a second-reagent storing position within a dispensing control chamber of the cartridge;

FIG. 6 is a perspective and vertically cross-sectional view of the cartridge of FIG. 5 with the reagent dispensing plunger in a solid form;

FIG. 7 is a transparent, perspective view of the cartridge of FIG. 5 with the reagent dispensing plunger in a second reagent loading position;

FIG. 8 is a transparent, perspective view of the cartridge of FIG. 5 with the reagent dispensing plunger in a second reagent, fully extended, dispensing position;

FIG. 9 is a transparent, exploded, perspective view of the cartridge of FIG. 5 with the reagent dispensing plunger separated from the cartridge;

FIG. 10 is a transparent, left side elevational view of the cartridge of FIG. 5;

FIG. 11 is a transparent, left side elevational view of the cartridge of FIG. 7;

FIG. 12 is a transparent, left side elevational view of the cartridge of FIG. 8;

FIG. 13 is a transparent, left side perspective view of the cartridge of FIG. 5;

FIG. 14 is a transparent, left side perspective view of the cartridge of FIG. 8;

FIG. 15 is a transparent, top plan view of the cartridge of FIG. 5;

FIG. 16 is a transparent, bottom plan view of the cartridge of FIG. 5;

FIG. 17 is a transparent, front elevational view of the cartridge of FIG. 5;

FIG. 18 is a transparent, rear elevational view of the cartridge of FIG. 5;

FIG. 19 is a transparent, right side elevational view of the cartridge of FIG. 5 with a first reagent in the reaction chamber and a second reagent held by the plunger within the dispensing control chamber;

FIG. 20 is a transparent, right side elevational view of the cartridge of FIG. 5 with a first reagent in the reaction chamber and a second reagent dispensed by the plunger into the dispensing control chamber;

FIG. 21 is a transparent, left side elevational view of the cartridge of FIG. 19; and

FIG. 22 is an enlarged, fragmentary, perspective view of an exemplary embodiment of a proximal opening and fill trough of a dispensing control chamber of the cartridge of FIG. 7.

### DETAILED DESCRIPTION OF THE EMBODIMENTS

As required, detailed embodiments of the systems, apparatuses, and methods are disclosed herein; however, it is to be understood that the disclosed embodiments are merely exemplary of the systems, apparatuses, and methods, which can be embodied in various forms. Therefore, specific structural and functional details disclosed herein are not to be interpreted as limiting, but merely as a basis for the claims and as a representative basis for teaching one skilled in the art to variously employ the systems, apparatuses, and methods in virtually any appropriately detailed structure. Further, the terms and phrases used herein are not intended to be limiting; but rather, to provide an understandable description of the systems, apparatuses, and methods. While the specification concludes with claims defining the features of the systems, apparatuses, and methods that are regarded as novel, it is believed that the systems, apparatuses, and methods will be better understood from a consideration of the following description in conjunction with the drawing figures, in which like reference numerals are carried forward.

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Alternate embodiments may be devised without departing from the spirit or the scope of the invention. Additionally, well-known elements of exemplary embodiments of the systems, apparatuses, and methods will not be described in detail or will be omitted so as not to obscure the relevant details of the systems, apparatuses, and methods.

Before the systems, apparatuses, and methods are disclosed and described, it is to be understood that the terminology used herein is for the purpose of describing particular embodiments only and is not intended to be limiting. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element. The terms “including” and/or “having,” as used herein, are defined as comprising (i.e., open language). The terms “a” or “an”, as used herein, are defined as one or more than one. The term “plurality,” as used herein, is defined as two or more than two. The term “another,” as used herein, is defined as at least a second or more. The description may use the terms “embodiment” or “embodiments,” which may each refer to one or more of the same or different embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact (e.g., directly coupled). However, “coupled” may also mean that two or more elements are not in direct contact with each other, but yet still cooperate or interact with each other (e.g., indirectly coupled).

For the purposes of the description, a phrase in the form “A/B” or in the form “A and/or B” or in the form “at least one of A and B” means (A), (B), or (A and B), where A and B are variables indicating a particular object or attribute. When used, this phrase is intended to and is hereby defined as a choice of A or B or both A and B, which is similar to the phrase “and/or”. Where more than two variables are present in such a phrase, this phrase is hereby defined as including only one of the variables, any one of the variables, any combination of any of the variables, and all of the variables, for example, a phrase in the form “at least one of A, B, and C” means (A), (B), (C), (A and B), (A and C), (B and C), or (A, B and C).

Relational terms such as first and second, top and bottom, and the like may be used solely to distinguish one entity or action from another entity or action without necessarily requiring or implying any actual such relationship or order between such entities or actions. The description may use perspective-based descriptions such as up/down, back/front, top/bottom, and proximal/distal. Such descriptions are merely used to facilitate the discussion and are not intended to restrict the application of disclosed embodiments. Various operations may be described as multiple discrete operations in turn, in a manner that may be helpful in understanding embodiments; however, the order of description should not be construed to imply that these operations are order dependent.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. As used herein, the terms “substantial” and “substantially” means, when comparing various parts to one another, that the parts being compared are equal to or are so close enough in dimension that one skill in the art would consider the same. Substantial and substantially, as used herein, are not limited to a single dimension and specifically include a range of values for those parts being compared. The range of values, both above and below (e.g., “+/−” or greater/lesser or larger/smaller), includes a variance that one skilled in the art would know to be a reasonable tolerance for the parts mentioned.

It will be appreciated that embodiments of the systems, apparatuses, and methods described herein may be comprised of one or more conventional processors and unique stored program instructions that control the one or more processors to implement, in conjunction with certain non-processor circuits and other elements, some, most, or all of the functions of the systems, apparatuses, and methods described herein. The non-processor circuits may include, but are not limited to, signal drivers, clock circuits, power source circuits, and user input and output elements. Alternatively, some or all functions could be implemented by a state machine that has no stored program instructions, or in one or more application specific integrated circuits (ASICs) or field-programmable gate arrays (FPGA), in which each function or some combinations of certain of the functions are implemented as custom logic. Of course, a combination of these approaches could also be used. Thus, methods and means for these functions have been described herein.

The terms “program,” “software,” “software application,” and the like as used herein, are defined as a sequence of instructions designed for execution on a computer system or programmable device. A “program,” “software,” “application,” “computer program,” or “software application” may include a subroutine, a function, a procedure, an object method, an object implementation, an executable application, an applet, a servlet, a source code, an object code, any computer language logic, a shared library/dynamic load library and/or other sequence of instructions designed for execution on a computer system.

Herein various embodiments of the systems, apparatuses, and methods are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

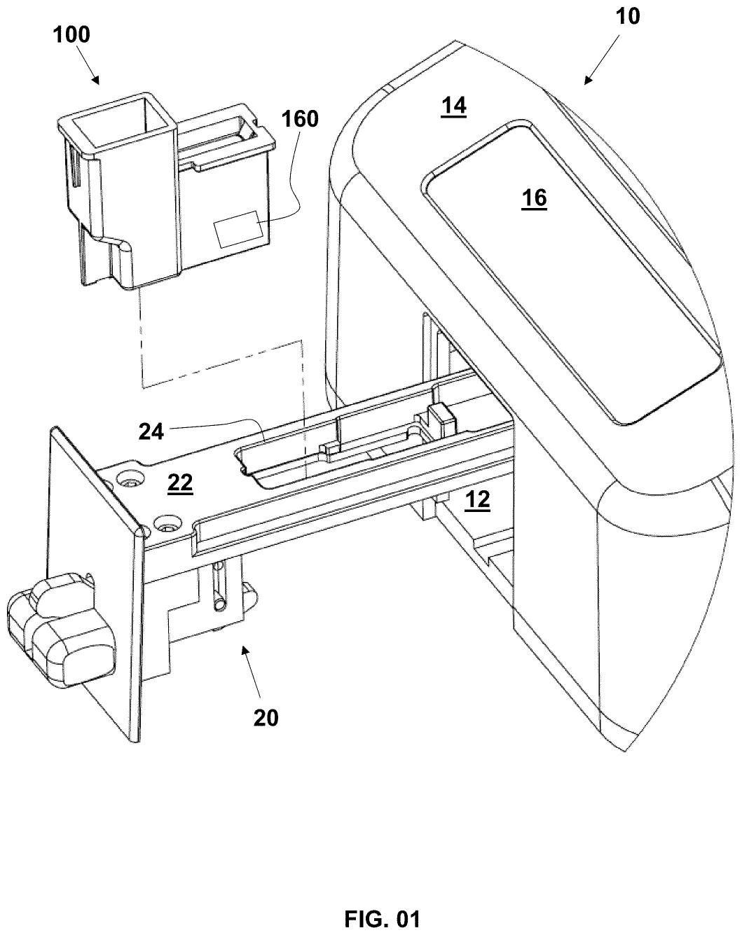

Described now are exemplary embodiments. Referring now to the figures of the drawings in detail and first, particularly to FIG. 1, there is shown a first exemplary embodiment of a photometric analyzer 10 with a modular reaction vessel cartridge 100. The analyzer 10 has a frame 12, a body 14, a display 16, and a cartridge drawer 20. The cartridge drawer 20 includes a drawer frame 22 defining a cartridge receiver 24. The cartridge drawer 20 further includes a dispensing system 30 having a dispensing actuator 32, in an exemplary embodiment, in the shape of movable rod or cylinder. The cartridge drawer 20 also includes a photometric reader 40 that is positioned with respect to the cartridge 100 to be able to photometrically read a substance within at least a lower portion of the cartridge 100, as described in further detail below. An exemplary embodiment of the photometric reader 40 is a Photodiode or photomultiplier tube attached to or working in conjunction with a proprietary board layout manufactured by Awareness Technology Inc. Also provided, but not illustrated, is a subsystems that controls temperature within and surrounding the cartridge 100, e.g., a heater, and a reader for RFID tags or indicators on the cartridges 100.

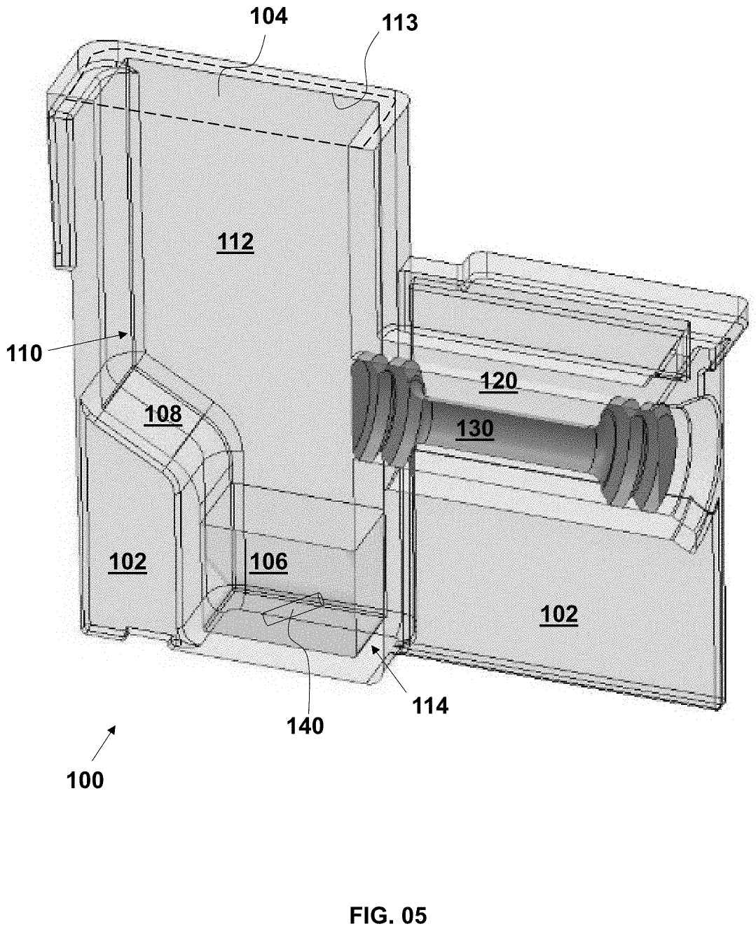

In a modular form, the cartridge 100 is a single use multi-chamber reaction vessel that includes a cartridge body 102, a sealing foil 104 (shown diagrammatically in FIG. 5 with dashed lines), and at least one commercially available first reagent 106 (which can be a solution, a blend, a compound, a suspension, a tincture, an infusion, an emulsion, a colloid, a gel, a dissolvent, an elixir, an extract, a fluid, a liquid, and/or an aerosol) of a single substance or a mixture of a number of substances). The body 102 defines a mixing or reaction chamber 110, also referred to as a cuvette. The mixing chamber 110 has an upper portion or filling chamber 112. The filling chamber 112 defines a filling orifice 113 into which the first reagent 106 is loaded at, for example, a facility at which the cartridge 100 is manufactured. There, the first reagent 106 is sealed inside the mixing chamber 110 with, for example, the sealing foil 104 at the filling orifice 113 to allow for transportation of the cartridge 100 without spillage of the first reagent 106.

As shown in FIG. 1, the cartridge 100 is placed into the cartridge receiver 24 to be processed. The cartridge 100 has two or more keying features that allow it to be keyed into the cartridge receiver 24 of the drawer 20 in one correct orientation. This safety feature eliminates all installation errors.

It may be desirable to mix reagent(s) actively within the read chamber 114. Accordingly, in an exemplary embodiment (e.g., FIG. 5), a mixing device 140 is also sealed with the first reagent 106 in the read chamber 114. The mixing device can be, for example, a magnetic mixer in the form of a rod having magnetic properties so that it can be moved about and/or rotated within the mixing chamber 110 by an adjacent, non-illustrated magnetically attractive rotating mixer housed either in the drawer 20 or below the drawer 20 within the body 14 of the analyzer 10. It may also be mixed by other methods such as sonic mixing or vibration.

In an exemplary embodiment, the temperature control system uses a heating resistor attached to a metal heatsink that is in contact with the cartridge. The temperature control system is initially activated at 100% of its power then is regulated down to maintain a desired temperature. The initial 100% power level is applied to allow for quicker time-to-temperature on the internal fluid; reduction of the power prevents the fluid from surpassing the desired temperature.

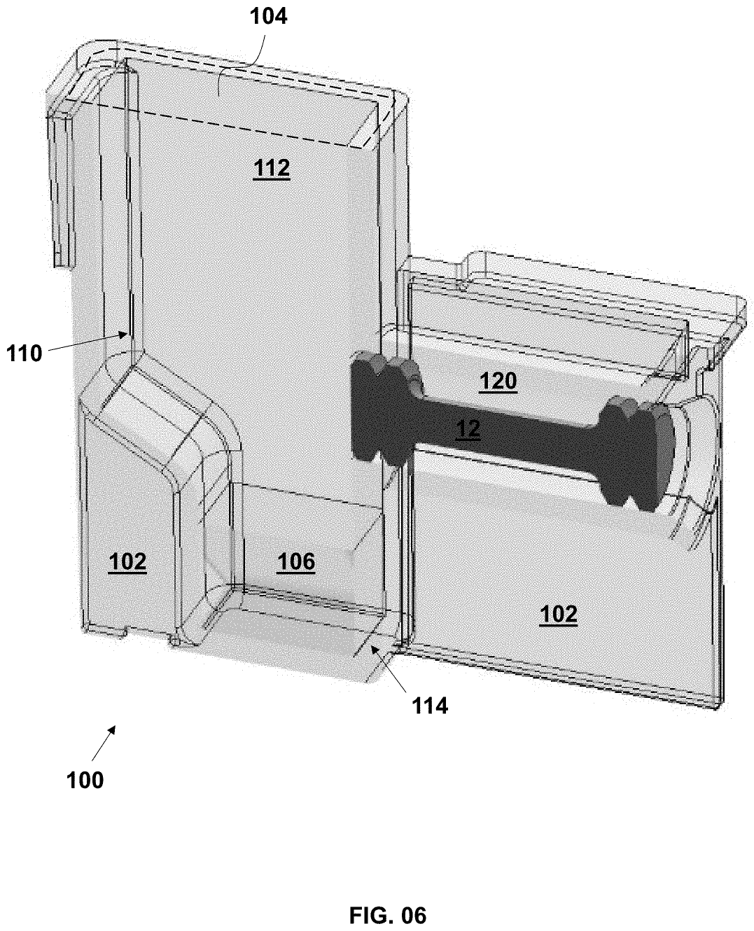

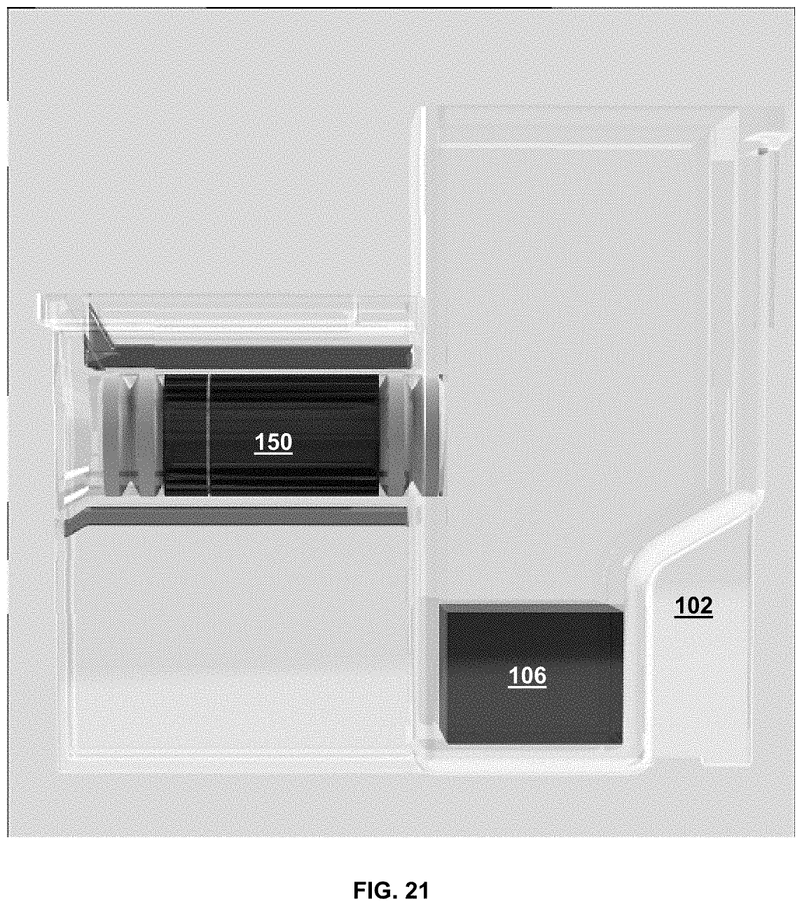

In a working orientation or state of the cartridge (for example, shown in FIGS. 5 and 6), the first reagent 106 resides in the lower portion or read chamber 114 of the cuvette 110 and is sealed at the upper opening by the foil 104. The cuvette 110 is also sealed at a side by a reagent-dispensing plunger 130, described in greater detail below. At least one portion of the read chamber 114 is optically clear so that readings of the reagent(s) in the read chamber 114 can be taken. Therefore, in one exemplary embodiment, the cartridge body 102 is of clear polystyrene, such as that shown in FIG. 21. In another exemplary embodiment, the opposing sides of the cartridge body 102 at the read chamber 114 are of clear polystyrene.

In this exemplary embodiment, adjacent and fluidically communicating with the upper portion 112 of the mixing chamber 110, the cartridge body 102 further defines a dispensing control chamber 120 having a proximal receiving opening 122 for receiving reagent therein and a distal dispensing opening 123. The reagent-dispensing plunger 130 movably resides inside the dispensing control chamber 120 and a portion thereof forms the second seal at the cuvette 110.

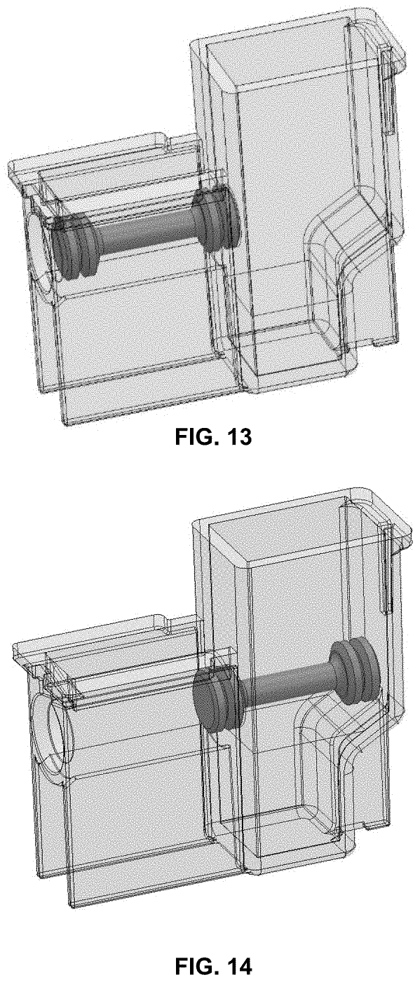

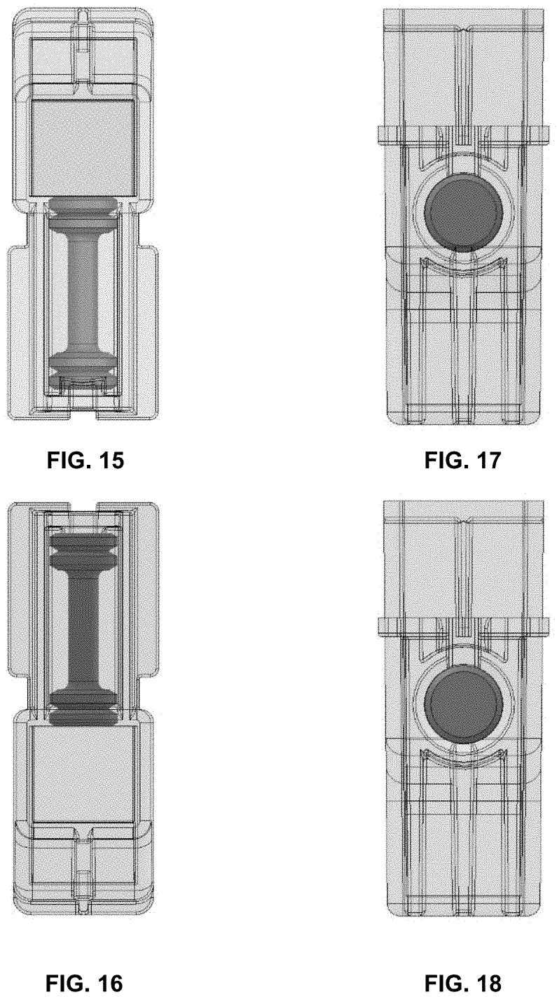

In an exemplary configuration, the plunger 130 has a shape and is located to restrain a second reagent 150 from contact with the read chamber 114 until the user desires to add the second reagent 150 to a substance(s) within the read chamber 114, for example, the first reagent 106 and a sample. The plunger 130 can be shaped in various forms. In one exemplary embodiment, which is shown in FIGS. 5 to 16, the plunger 130 is in the shape of a barbell (or dumbbell or H-shaped in cross-section), having a center portion that is narrower than each of the two opposing end portions. Each of the end portions forms a liquid-tight seal between the end portion and, in this exemplary case, an annular or peripheral surface portion of the dispensing control chamber 120. One end of the plunger 130 is a dispensing end 131 and the other opposing end is a loading end 132. In another exemplary embodiment, the plunger 130 can be mushroom shaped, in which the dispensing end (closer to the filling chamber 112) is larger than a loading end (further away from the filling chamber 112). One exemplary embodiment of the mushroom-shaped plunger 130 has a wide cylinder at the distal end and a narrower portion of the cylinder forming the proximal end.

Configurations of the plunger 130 described and shown (and equivalent alternative shapes) have a desirable attribute of being able to adjust a volume of the second reagent 150 being dispensed by simply varying one or more portions of the plunger 130. With regard to the exemplary embodiment of FIG. 5, for example, the center cylinder between the two larger diameter ends can be expanded in radius for adding less of the second reagent 150 and can be shortened in radius for adding more of the second reagent 150. The thicknesses of the dispensing end and/or loading end can be reduced for adding more of the second reagent 150 or expanded for adding less of the second reagent 150. Also, the length of the center cylinder can be expanded for adding more of the second reagent 150 and can be shortened in radius for adding less of the second reagent 150. The plunger 130, for example in FIG. 5, has a single area 120 to hold the second reagent 150. In a desirable, alternative, exemplary configuration, the plunger 130 has an intermediate expanded portion with peripheral seals between the front and back ends of the plunger 130 to change the single second reagent addition to a multi-reagent addition. Providing the plunger 130 with multiple stop positions allows the system to dispense multiple reagents using a single plunger. These plungers 130 can be referred to as single-stop or multi-stop.

Alternatively, or additionally, both the diameter of the dispending control chamber 120 and the size of the plunger 130 can be increased/decreased to respectively increase or decrease the volume to be dispensed into the read chamber 114 (this adaptation applies equally to plungers configured to add two or more reagents). The plunger and the dispending control chamber 120 need not be circular in cross-section as shown; they can take any shape that permits the plunger 130 to move therein for both filling the chamber 120 and emptying the chamber 120 to dispense the second reagent 150 (or subsequent reagents) into the cuvette 110. In this manner, a modular set of different cartridges 100 with differing diameter dispending control chambers 120 can be combined with sets of plungers 130 having different diameters at the ends or middle thereof. The differing dispensing control chambers 120 and different diameters of plunger portion(s) within the second reagent 150 increase or decrease the volume of the second reagent 150 that can be dispensed into the read chamber 114.

An exemplary material of which the plunger 130 is made is PTFE (i.e., TEFLON′) or an equivalently inert material, such as PVDF, PFA, PEEK, and CPVC. In exemplary embodiments, both materials selected for the cartridge 100, including the cartridge body 102, the sealing foil 104, and the plunger 130 are inert to any reagents and/or samples housed in the cartridge 100 or that may come in contact with the plunger 130.

During loading of the first reagent 106 in the cuvette 110 and loading of the second reagent 150 in the pipetting subassembly (102, 120, 122, 130), and subsequent transportation of the loaded and sealed cartridge 100, the plunger 130 is in a storage or default position. The storage position is depicted in FIGS. 5, 6, 10, 13, 15, 16, and 19.

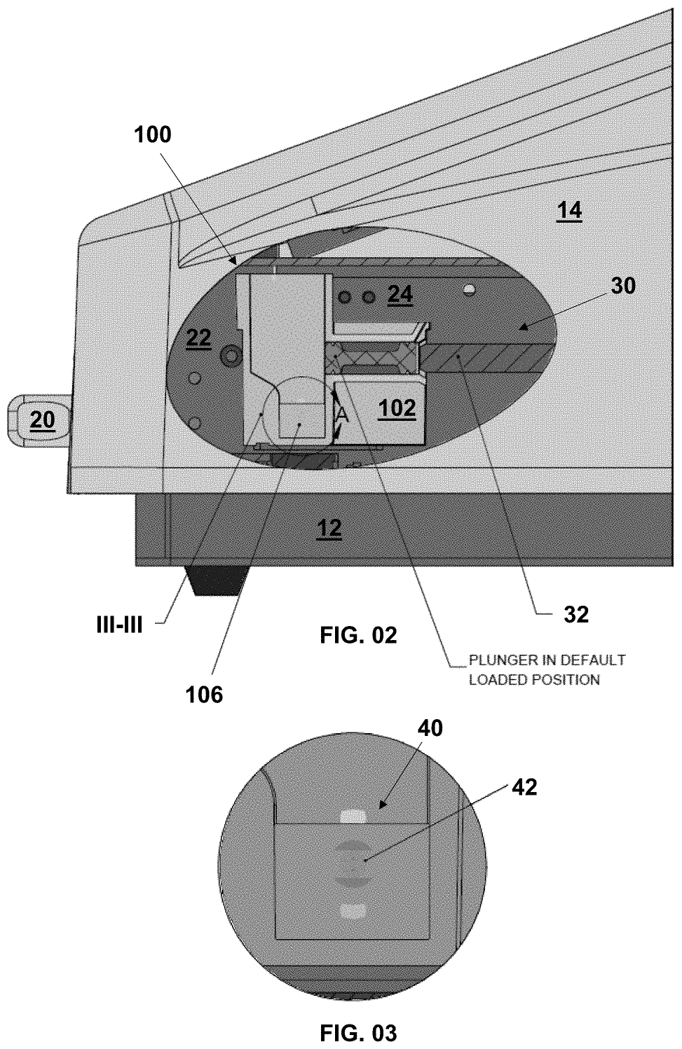

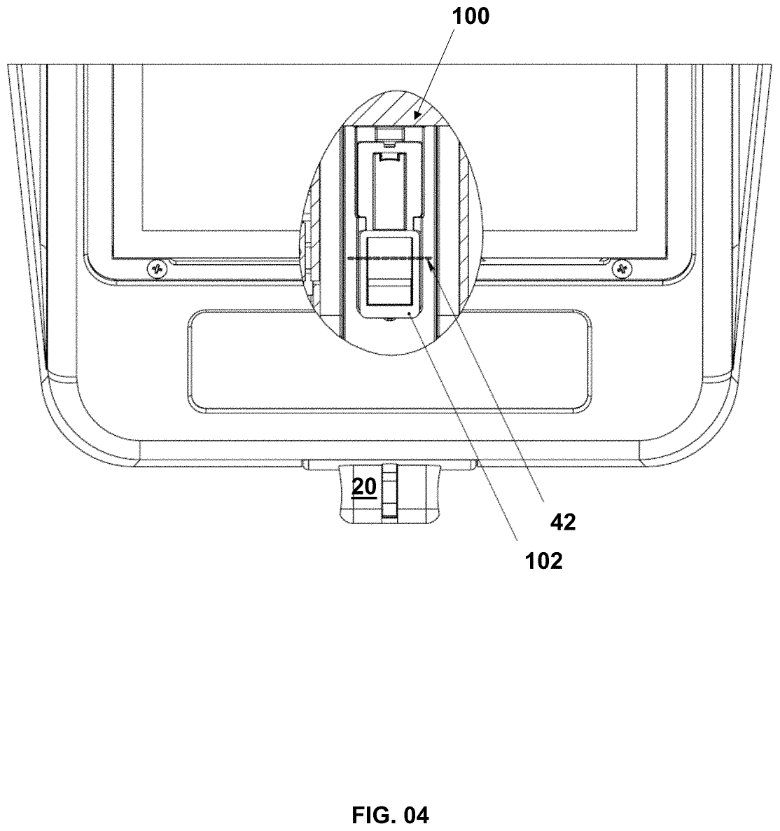

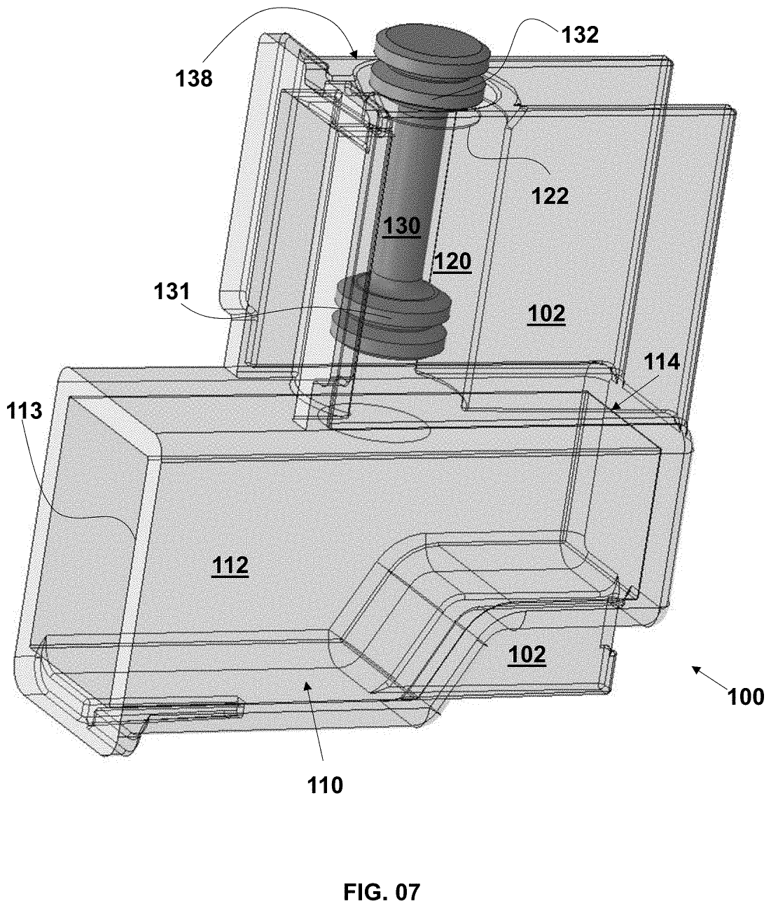

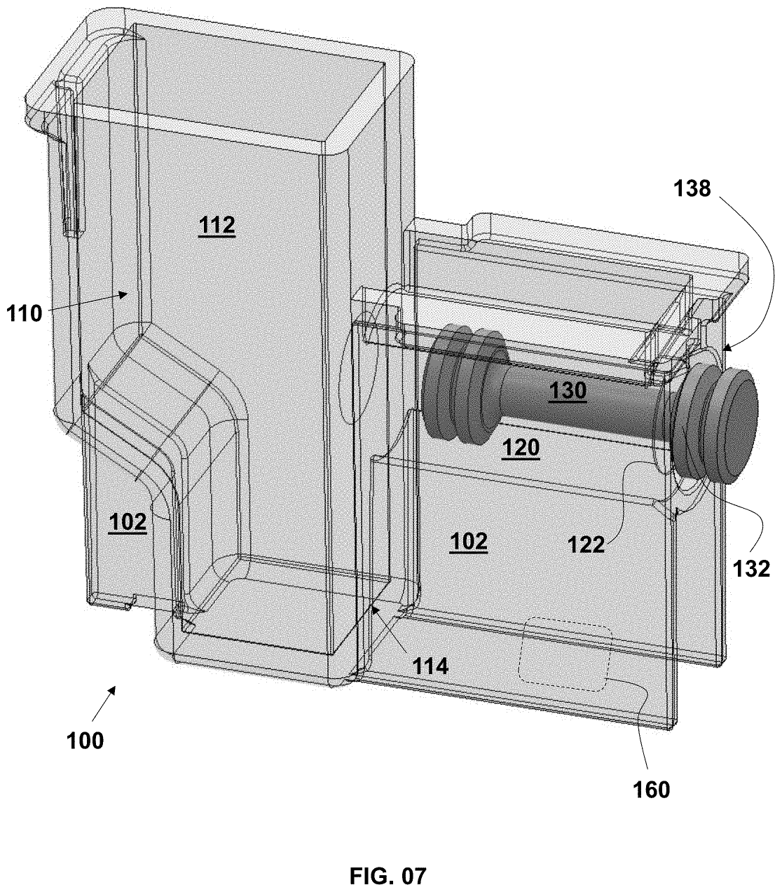

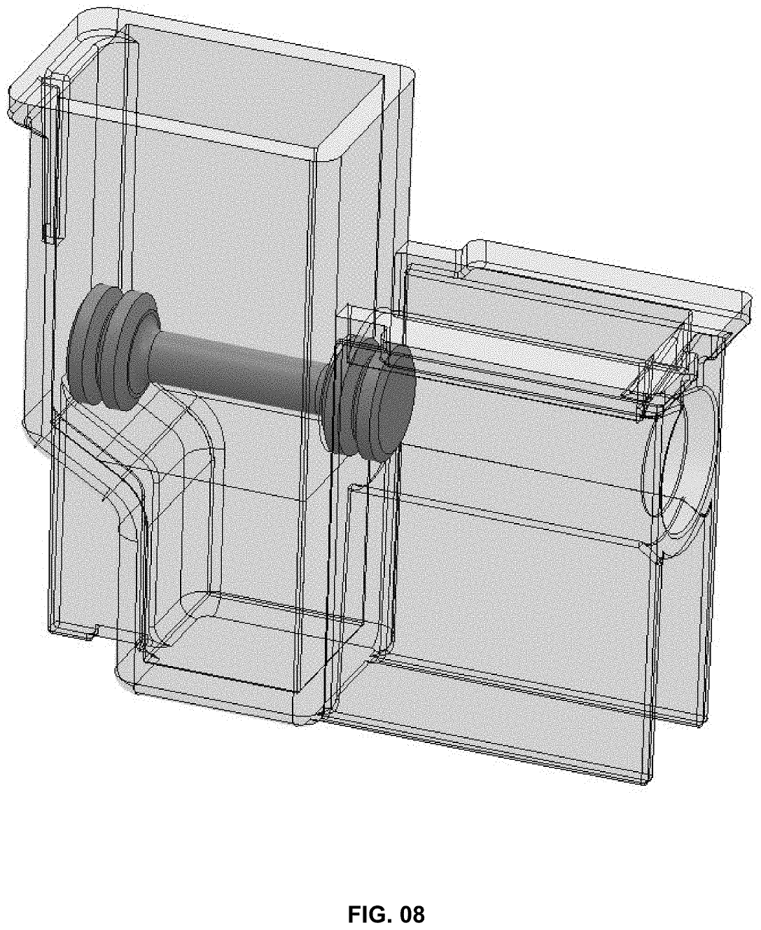

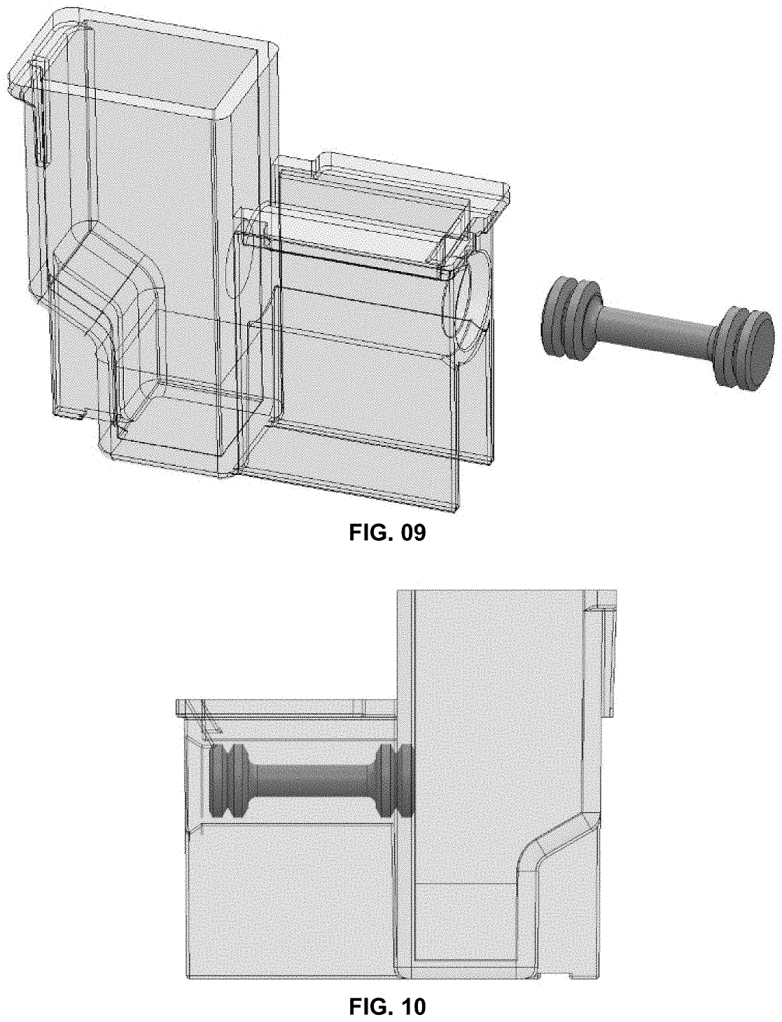

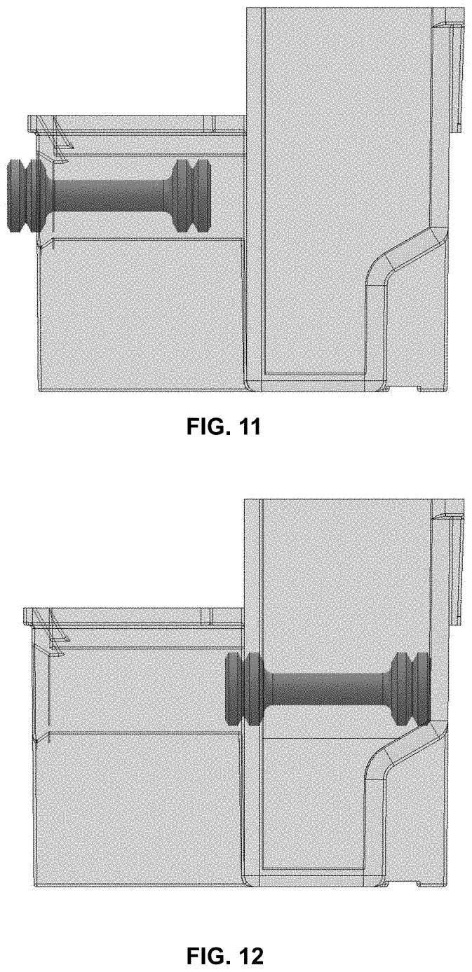

The reagent-dispensing plunger 130 works in conjunction with the dispensing system 30 of the analyzer 10 and reference is made to FIGS. 2 to 4. The plunger 130 is configured to seal the dispensing control chamber 120 from the mixing chamber 110 until dispensing of the second reagent 150 into the first reagent 106 is desired. In various configurations of the plunger 130, the plunger 130 is moved between a number of functional positions including, for example, a loading position (e.g., FIGS. 7 and 11), a holding or retaining or transporting position (e.g., FIGS. 5, 6, 10, 13, 15, 16, and 19), at least one dispensing position (e.g., FIGS. 8, 12, 14, and 20), and a separated or disinfecting or sterilizing or cleaning position (e.g., FIG. 9). In an exemplary embodiment, the plunger 130 is driven by the dispensing actuator 32 (see FIG. 2) that is, in turn, moved or driven by a non-illustrated DC motor within the body 14 in an exemplary configuration. Timing of the second reagent 150 dispense varies depending on test criteria and occurs at a respective time during a test, which time is controlled by programing in the analyzer 10.

The plunger 130 has multiple functions during the process of performing analysis of reagents 106 in the cartridge 100. These functions are described in the following text but the functions do not necessarily occur in the order that is described.

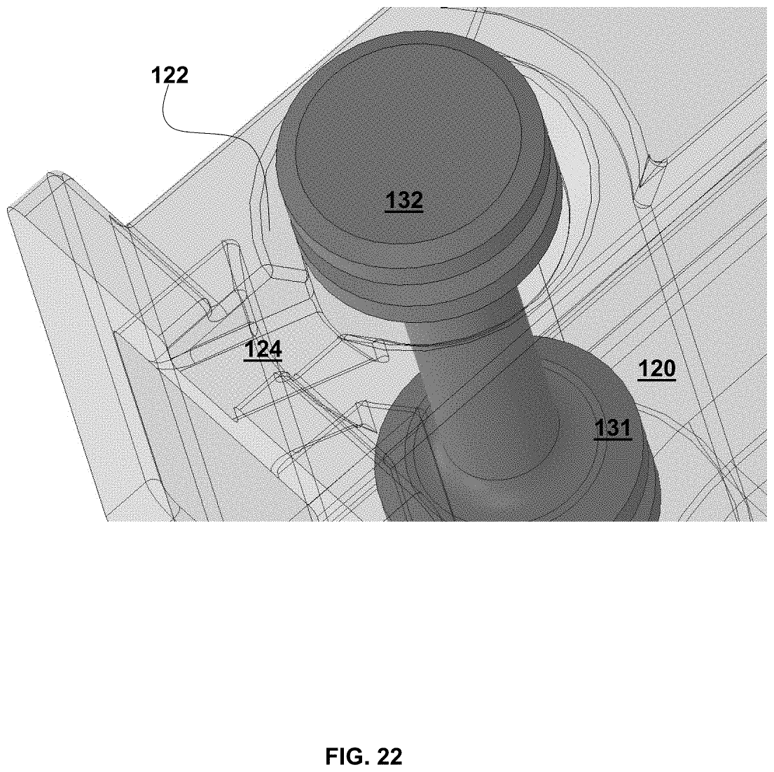

In an exemplary embodiment, the dispensing control chamber 120 is filled by, for example, the manufacturer. (It is also possible for the dispensing control chamber 120 of the cartridge 100 to be filled by a technician by hand pipetting the second reagent 150 therein before or after the first reagent 106 is sealed in the cuvette 110. A further alternative for filling the dispensing control chamber 120 is with a non-illustrated automated system. After filling, the plunger 130 is moved into the loading position (e.g., FIGS. 7 and 11). In this state, which is best depicted in FIG. 7 where the plunger 130 is lifted vertically out of the dispensing control chamber 120, there is a loading gap 138 between the loading or proximal end 132 of the plunger and a proximal opening 122 of the dispensing control chamber 120. To assist in filling the dispensing control chamber 120, the proximal opening 122 is provided with a fill trough 124, which is depicted in the enlarged portion of FIG. 22.

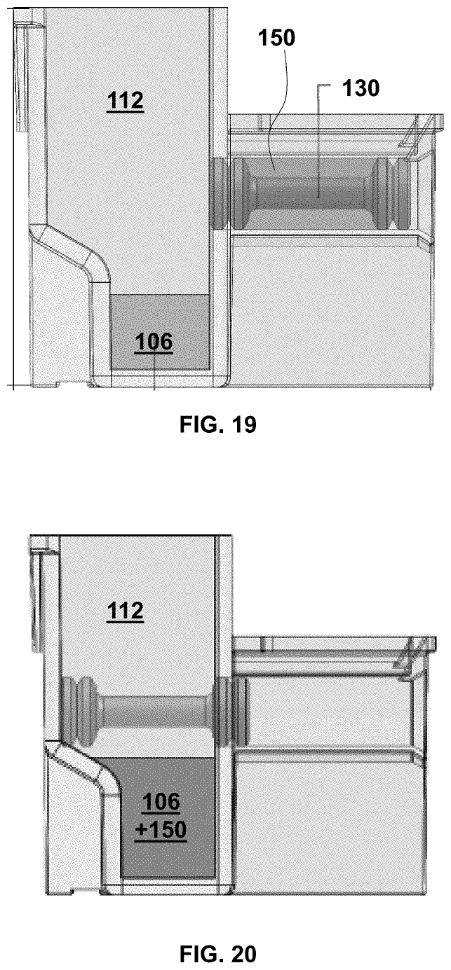

When a desired amount of the second reagent 150 is present in the dispensing control chamber 120 (e.g., FIG. 19) with the plunger 130 sealed, the analyzer 10 is primed and ready to combine the reagents 106, 150. Dispensing of the second (or subsequent reagents) reagent into the read chamber 114 occurs at a time set by the analyzer 10. The analyzer 10 knows or identifies the test being done, for example, using a label (e.g., an RFID or a barcode 160) that is present somewhere on the reaction vessel cartridge 100. Once the test is identified, programming stored in the analyzer 10 dispenses the second reagent 150 when needed.

The plunger 130 is shaped and configured to allow the second reagent 150 (or multiple reagents) to sit between multiple sealing surfaces, thereby creating a low pressure dispense. The low pressure dispense allows the fluid/substance to flow out of the dispensing control chamber 120 evenly. This greatly reduces the chance of the fluid spraying out or splashing due to a pressure build up, which splashing occurs routinely in the prior art to contaminate the analyzer. Further, utilization of the plunger, with its peripheral sealing (e.g., without or with appropriately inert gaskets) prevents any of the second reagent from being left on the walls of the dispensing control chamber 120. The prior art uniformly has this disadvantageous attribute. The exemplary configuration also eliminates contamination from cartridge 100 to cartridge 100 during multiple uses of the analyzer 10 because no part of the analyzer 10 touches any of the fluids residing anywhere in the cartridge 100, e.g., within the chambers 112, 120. Further, the shape of the plunger 130 seals the fluid of the second reagent 150 between two ends with a material or a rod connecting the two sealing ends. This shape or configuration ensures that all of the force exerted by the dispensing actuator 32 is applied to the plunger 130 and not to the fluid of the second reagent 150.

Prior to conducting the analysis or test, each of the lower chamber 114 and the dispensing control chamber 120 is filled with a specific volume of the first/second reagent 106, 150, respectively, the respective volumes being dependent upon the test being conducted. To combine the reagents 106, 150, the dispensing system 30 is caused to move the dispensing actuator 32 against the plunger 130 and continue movement until the plunger 130 reaches a given extent into the filling chamber 112. For example, the plunger 130 can move completely across the upper portion to touch the far/opposite wall within the cuvette in a dispensing position that is illustrated in FIG. 20. In this position, and with the plunger 130 in the exemplary shape illustrated, the second reagent 150 is entirely removed from dispensing control chamber 120 and placed into the read chamber 114. In the exemplary configuration shown, the cross-section of the read chamber 114 expands laterally at a transition 108 (see, e.g., FIG. 5)—from a concentrated, tightly toleranced volume into a much larger volume of the upper portion 112. The larger depth of the upper chamber 112 above the transition 108 allows the plunger 130 to be fully extended into the upper chamber 112 so that, for example, the proximal end 132 of the plunger 130 is even with or contacts a distal wall of the upper chamber 112 while, at the same time, the distal surface of the distal end 131 is substantially even with or at a chamfer of the exit orifice of the dispensing control chamber 120. In such a configuration, no amount of the second reagent 150 or an insignificantly small amount remains in the dispensing control chamber 120 or all of the second reagent 150 enters the read chamber 114.

In an exemplary embodiment, the maximum volume of the control chamber 120 is approximately 280 μL. In an exemplary embodiment, the minimum volume of the reading or reaction chamber 110 is approximately 580 μL. In an exemplary embodiment, the minimum volume of the second reagent is approximately 50 μL and the maximum volume is approximately 280 μL. The minimum read volume within the read chamber 114 is approximately 500 μL (including the first reagent 106, the second reagent 150, and the sample). In an exemplary embodiment, the maximum read volume is approximately 4 mL, in particular, approximately 1.08 mL. With these volumes selected, when the reagents 106, 150 are combined, a total volume of liquid in the entire mixing chamber 110 is no more than approximately 4 mL, which combination is shown in FIG. 20. In this exemplary embodiment, a front-to-back depth of the cartridge 100 is approximately 1.5 inches and a height of the cartridge 100 is approximately 1.33 inches. In a particularly desirable configuration, the reaction chamber 110 can hold a maximum volume of 4 mL (4000 μL).

In a dispensing or mixing orientation or state, the sample to be tested is either already in the read chamber 114 or is added to the read chamber 114. In either configuration, the plunger 130 moving into the dispensing position transfers the second reagent 150 into the read chamber 114 of the cartridge 100, which contains or is about to contain the sample to be tested. With the transfer, the second reagent 150 mixes with the first reagent 106, thereby mixing the sample with both reagents 106, 150. In another exemplary configuration, the first reagent 106 is or contains the sample, calibrator, or control.

In an alternative exemplary configuration, the analyzer can place the first reagent 106 and the sample in the read chamber 114 through a non-illustrated internal transfer device before the plunger 130 moves to the dispensing position (or dispensing positions with a multi-reagent plunger configuration having more than one actuator stop position.

In another alternative exemplary configuration, the analyzer can have two or more dispensing actuators 32 and the cartridge 100 has two or more instances of the pipetting subassembly, including a second or more of the dispensing control chamber 120′, the proximal opening 122′, the fill trough 124′, and the plunger 130. In that second or more pipetting subassembly, a third or more reagent 150′ is present for dispensing into the cuvette 110. These plungers 130 can be single stop or multi-stop.

In an exemplary process for mixing the reagents 106, 150 and conducting a test, the plunger 130 is left in the dispensing position (e.g., FIG. 20) after dispensing the second reagent 150 even where the dispensing actuator 32 is retracted back out of the cartridge 100. Because the cartridge 100 is a single-use device, there is no disadvantageous effect on the test being conducted. Once the second reagent 150 has been dispensed, the plunger 130 stays in that position and is discarded after the test along with the cartridge 100.

As an exemplary safety configuration, in the loading and dispensing positions, the plunger 130 is configured to lock the cartridge 100 in the drawer 20 and prevent removal until after the reagents 106, 150 and the sample are mixed in the read chamber 114. In an exemplary configuration, the plunger 130 not only locks the cartridge 100 in the drawer 20, the plunger 130 also locks the drawer 20 in a closed position with respect to the frame 12 of the analyzer 10. In such a configuration, the plunger 130 is, thereby, configured to unlock and release the drawer 20 from the analyzer 10 when testing of the sample is complete.

In an exemplary process for completing analysis of the sample and/or reagents 106, 150, the mixing device 140 is activated and actively stirs or agitates the substances within the read chamber 114, for example, the first and second reagents 106, 150 and the sample. In a first exemplary embodiment of the mixing device 140, the cartridge 100 contains, within the read chamber 114, a small, magnetically active stirrer that is attracted to/repelled by a magnet or through vibration. This embodiment of the mixing device 140 also includes, at the frame 12 of the analyzer 10 adjacent the read chamber 114, a magnetized inducer that is, for example, attached to a motor such that activation of the motor spins the magnetized inducer, which, in turn, spins and/or otherwise moves the stirrer. A motor may also be used to create a vibration that will agitate and mix the reagents and sample. The inducer can be, for example, underneath or at the side of the read chamber 114. Magnetically active materials and stirrers allow the analyzer 10 to perform contactless mixing within the read chamber 114.

The analyzer 10 handles the single-use cartridge 100 placed in the slidable drawer 20. An exemplary embodiment of the analyzer 10 utilizes a multi-wavelength LED optical system to take measurements of the substance(s)/fluid(s) in the read chamber 114. The optical signal from the LED passes through the sample and is read with either a photodiode or a similar device. The transmission and reading are controlled by the circuit and programming of the analyzer 10.

The cartridge 100 is provided with a label 160 (see, e.g., FIG. 1). The label 160 contains information to supply to the computer within the analyzer 10 all relevant test and reagent data the analyzer 10 needs to accurately run the test. In a process for automatically reading the label, the label is, for example, an RFID or a barcode 160 and the analyzer 10 further comprises an RFID or barcode reader.

In an exemplary configuration, the display 16 of the analyzer 10 is a touch display, for example, a five-inch display, that provides information to the user and controls basic functions of the machine. The analyzer 10 also is equipped with other mechanical components, such as a non-illustrated heater, the mechanically or electrically driven plunger (e.g., a rod 32), and the mixer 140 (e.g., a magnetically driven, contactless mixer). The heater is adjacent the read chamber 114 of the cartridge 100 and is configured to keep the sample and reagents 106, 150 at a stabilized temperature for the duration of the test that is to be undertaken by the analyzer 10 using the cartridge 100, the stabilized temperature being dependent upon the test being conducted. An exemplary embodiment of the heater is a commercially available resistor mounted to a metal heat transfer plate, manufactured by ATI, that is controlled through a feedback circuit and software/firmware. Another exemplary embodiment of the heater is a resistive element (e.g., a resistor) attached to an aluminum plate and a feedback circuit that is controlled by firmware/software. In an exemplary embodiment, the heater keeps the read chamber at a controlled temperature of between approximately 25° C. and approximately 37±0.5° C. In an exemplary embodiment, the heater can operate from room temperature up to approximately 65° C.

It is noted that various individual features of the inventive processes and systems may be described only in one exemplary embodiment herein. The particular choice for description herein with regard to a single exemplary embodiment is not to be taken as a limitation that the particular feature is only applicable to the embodiment in which it is described. All features described herein are equally applicable to, additive, or interchangeable with any or all of the other exemplary embodiments described herein and in any combination or grouping or arrangement. In particular, use of a single reference numeral herein to illustrate, define, or describe a particular feature does not mean that the feature cannot be associated or equated to another feature in another drawing figure or description. Further, where two or more reference numerals are used in the figures or in the drawings, this should not be construed as being limited to only those embodiments or features, they are equally applicable to similar features or not a reference numeral is used or another reference numeral is omitted.

The foregoing description and accompanying drawings illustrate the principles, exemplary embodiments, and modes of operation of the systems, apparatuses, and methods. However, the systems, apparatuses, and methods should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the systems, apparatuses, and methods as defined by the following claims.

1. A modular reaction vessel cartridge for a photometric analyzer, comprising:
a cartridge body comprising:
an integral cuvette comprising:
a filling chamber defining:
an upper orifice through which a first fluid is to be communicated; and
a dispensing opening through which a fluid is to be communicated; and
a read chamber below the filling chamber and fluidically connected to the filling chamber; and
an integral pipetting portion comprising:
a dispensing control chamber:
having an exit fluidically communicating with the dispensing opening;
having an interior surface; and
defining a receiving opening through which a second fluid is to be communicated; and
a dispensing plunger comprising:
a loading end fluid tightly sealed to the interior surface of the dispensing control chamber; and
a dispensing end fluid tightly sealed to the interior surface of the dispensing control chamber,
wherein the dispensing plunger is movably disposed within the dispensing control chamber such that, responsive to the dispensing end being moved from the dispensing control chamber into the filling chamber, fluid in the dispensing control chamber is dispensed into at least the filling chamber without fluid in the cartridge body being transferred out from the cartridge body.

2. The modular reaction vessel cartridge according to claim 1, wherein the cuvette comprises a first reagent in the read chamber selected from at least one of a solution, a blend, a compound, a suspension, a tincture, an infusion, an emulsion, a colloid, a gel, a dissolvent, an elixir, an extract, a fluid, a liquid, an aerosol of one of a single substance or a mixture of substances.

3. The modular reaction vessel cartridge according to claim 1, which further comprises:
the first fluid as a first reagent in the read chamber; and
the second fluid as a second reagent in the dispensing control chamber.

4. The modular reaction vessel cartridge according to claim 3, wherein the cartridge body further comprises an identifier indicating a set of test data associated with the first and second reagents.

5. The modular reaction vessel cartridge according to claim 1, which further comprises a mixer within the read chamber and configured to mix fluids within the read chamber.

6. The modular reaction vessel cartridge according to claim 5, wherein the mixer is at least one of a magnetic mixer, a sonic mixer, and a vibration mixer.

7. The modular reaction vessel cartridge according to claim 1, which further comprises a cover fluid-tightly sealing the upper orifice.

8. The modular reaction vessel cartridge according to claim 7, wherein the cover is a sealing foil.

9. The modular reaction vessel cartridge according to claim 1, wherein the cuvette has a maximum volume of approximately 4000 μl.

10. The modular reaction vessel cartridge according to claim 1, wherein at least a portion of the read chamber is optically clear.

11. The modular reaction vessel cartridge according to claim 1, wherein the dispensing plunger is a single-stop having a barbell shape and forms peripheral liquid-tight seals between the dispensing plunger and the dispensing control chamber.

12. The modular reaction vessel cartridge according to claim 1, wherein the dispensing plunger is a multi-stop shape to define peripheral liquid-tight seals between wider portions of the dispensing plunger and the dispensing control chamber.

13. The modular reaction vessel cartridge according to claim 1, wherein the dispensing plunger is a modular set of a plurality of dispensing plungers each having a different
shape from one another to define different second fluid volumes between each of the plurality of dispensing plungers and the dispensing control chamber.

14. The modular reaction vessel cartridge according to claim 13, wherein the shape differs by at least one of an intermediate diameter, a proximal end thickness, a distal end thickness, and length.

15. The modular reaction vessel cartridge according to claim 1, wherein a material of the dispensing plunger is at least one of PTFE, PVDF, PFA, PEEK, and CPVC.

16. The modular reaction vessel cartridge according to claim 1, wherein:
the filling chamber has an interior surface portion opposite the dispensing opening at a given distance; and
the dispensing plunger has:
a distal surface; and
a longitudinal length at least as long as the given distance such that, in a full dispensing position, the distal surface touches the interior surface portion.

17. The modular reaction vessel cartridge according to claim 16, wherein the read chamber and the filling chamber define a transition therebetween having a cross-section that expands laterally from the read chamber toward the filling chamber.

18. The modular reaction vessel cartridge according to claim 1, wherein the dispensing control chamber has a maximum volume of approximately 280 μL.

19. The modular reaction vessel cartridge according to claim 1, wherein the cuvette has a minimum volume of approximately 580 μL.

20. The modular reaction vessel cartridge according to claim 1, wherein the cuvette has a maximum volume of approximately 4000 μL.

21. The modular reaction vessel cartridge according to claim 1, wherein the read chamber has a minimum volume of approximately 500 μL.

22. The modular reaction vessel cartridge according to claim 1, wherein the cartridge body has a front-to-back depth of approximately 1.5 inches and a height of approximately 1.33 inches.

23. A modular reaction vessel cartridge for a photometric reagent analyzer, comprising:
a hollow cuvette defining:
a filling chamber defining an upper orifice through which a first reagent is to be communicated;
a dispensing opening below the upper orifice and through which a second reagent is to be communicated into the filling chamber;
a read chamber below the dispensing opening and fluidically communicating with the filling chamber; and
a dispensing control chamber:
above the read chamber;
having an exit fluidically communicating with the dispensing opening;
defining a receiving opening through which the second reagent is to be communicated into the dispensing control chamber; and
a dispensing plunger slidably and fluid-tightly disposed in the dispensing control chamber and defining therebetween a volume shaped to hold the second reagent such that, responsive to the dispensing plunger being moved into the filling chamber, fluid in the dispensing control chamber is dispensed into at least the filling chamber without fluid in the cuvette being transferred out from the cuvette.

24. A photometric analyzer, comprising:
a modular reaction vessel cartridge according to claim 1; and
a frame comprising a cartridge drawer movably connected to the frame, the cartridge drawer comprising:
a cartridge receiver shaped to removably contain the reaction vessel cartridge; and
a dispensing system having a dispensing actuator operatively connected to the dispensing plunger when the reaction vessel cartridge is disposed in the cartridge receiver to move the dispensing plunger; and
a body connected to the frame and comprising a display configured to provide information to a user.

25. The photometric analyzer according to claim 24, wherein the dispensing actuator is configured to movably dispose the dispensing plunger within the dispensing control chamber such that, fluid in the dispensing control chamber is dispensed into at least the filling chamber without fluid in the cartridge body being transferred out from the cartridge body.

26. The photometric analyzer according to claim 24, wherein at least one of the dispensing actuator and the dispensing plunger is configured to removably lock the cartridge body in the cartridge drawer and prevent removal of the cartridge body until unlocking occurs.

27. The photometric analyzer according to claim 24, wherein at least one of the dispensing actuator and the dispensing plunger is configured to removably lock the cartridge drawer in a closed position with respect to the frame and prevent movement of the cartridge drawer until unlocking occurs.

28. The photometric analyzer according to claim 24, wherein at least one of the frame and the cartridge drawer comprises a photometric reader disposed with respect to the reaction vessel cartridge to photometrically read a substance within at least the read chamber of the reaction vessel cartridge.

29. The photometric analyzer according to claim 24, wherein at least one of the frame and the cartridge drawer comprises a heater configured to control temperature within and at least the read chamber of the reaction vessel cartridge.

30. The photometric analyzer according to claim 29, wherein the heater keeps the read chamber at a controlled temperature of between approximately 25° C. and approximately 37±0.5° C.

31. The photometric analyzer according to claim 24, wherein at least one of the frame and the cartridge drawer comprises a reader configured to read an identification indicator on the reaction vessel cartridge.

32. The photometric analyzer according to claim 31, wherein the identification indicator is one of an RFID tag and a barcode.
